(19) United States
(12) Patent Application Publication
(10) Pub. No.: US 2016/0150136 A1
(43) Pub. Date: May 26, 2016

(54) IMAGE SENSING DEVICE WITH COVER PLATE HAVING OPTICAL PATTERN THEREON

(71) Applicants: HIMAX TECHNOLOGIES LIMITED, Tainan City (TW); Himax Imaging Limited, Tainan City (TW)

(72) Inventors: Chung-Chi CHEN, Tainan City (TW); Wen-Shun WU, Tainan City (TW); Kuo-Liang TAI, Tainan City (TW)

(21) Appl. No.: 14/641,452

(22) Filed: Mar. 9, 2015

Related U.S. Application Data
(60) Provisional application No. 62/083,322, filed on Nov. 24, 2014.

(51) Int. Cl. H04N 5/225

(52) U.S. Cl. CPC H04N 5/2253; H04N 5/2254

(57) ABSTRACT

An image sensing module is provided, which includes an image sensor, a cover plate and an optical pattern. The image sensor has a light sensitive area for receiving incident light and a peripheral area surrounding the light sensitive area. The cover plate is disposed on the image sensor. The optical pattern is disposed on the cover plate, and is located above the light sensitive area of the image sensor.

### RELATED APPLICATIONS

This application claims priority to U.S. provisional Application Ser. No. 62/083,322, filed Nov. 24, 2014, which is herein incorporated by reference.

### BACKGROUND

1. Field of Disclosure

The invention relates to an image sensing module, and more particularly, to an image sensing module including an optical pattern on a cover plate, a method of fabricating the image sensing module and a camera apparatus for the same.

2. Description of Related Art

With the development of semiconductor technology, image sensing devices may be manufactured by wafer level processes and may be applied to electronic devices such as digital cameras, smart phones, tablets, and so on. In an image sensing module, a cover plate is used to protect the image sensor against such as dust and scratch from an external force. However, a known cover plate only provides protection function and does not provide any additional feature.

### SUMMARY

In the invention, an image sensing module is provided, which includes a cover plate with an optical pattern disposed thereon. Such optical pattern improves image sensing quality and color shift of the image sensing module. In addition, a camera apparatus with the image sensing module can improve performances such as chief ray angle (CRA) improving, correction of image distortion and focal length calculation accuracy.

An aspect of the invention is to provide an image sensing module. The image sensing module includes an image sensor, a cover plate and an optical pattern. The image sensor has a light sensitive area for receiving incident light and a peripheral area surrounding the light sensitive area. The cover plate is disposed on the image sensor. The optical pattern is disposed on the cover plate and located above the light sensitive area of the image sensor.

In one or more embodiments, the optical pattern includes microstructures substantially covering phase detection auto focus (PDAF) pixels of the image sensor in a light incident direction respectively.

In one or more embodiments, the area of the optical pattern is substantially the same as or larger than the light sensitive area of the image sensor.

In one or more embodiments, the optical pattern substantially covers the light sensitive area of the image sensor in a light incident direction.

In one or more embodiments, the image sensing module further includes at least one alignment mark on the cover class for a lens module to be aligned with the image sensing module. The alignment mark is located above the peripheral area of the image sensor.

Another aspect of the invention is to provide a method of fabricating an image sensing module. The method includes the following steps. An image sensor having a light sensitive area is provided for receiving incident light and a peripheral area surrounding the light sensitive area. A cover plate, which has an optical pattern formed thereon, is mounted on the image sensor, where the optical pattern is located above the light sensitive area of the image sensor.

In one or more embodiments, the optical pattern is formed to include microstructures the microstructures substantially covering PDAF pixels of the image sensor in a light incident direction respectively.

In one or more embodiments, the area of the optical pattern is substantially the same as or larger than the light sensitive area of the image sensor.

In one or more embodiments, the optical pattern is formed to substantially cover the light sensitive area of the image sensor in a light incident direction.

In one or more embodiments, the method further includes forming at least one alignment mark on the cover class for a lens module to be aligned with the image sensing module. The alignment mark is located above the peripheral area of the image sensor.

Another aspect of the invention is to provide a camera apparatus. The camera apparatus includes a lens module for directing incident light and an image sensing module. The image sensing module includes an image sensor, a cover plate and an optical pattern. The image sensor has a light sensitive area for receiving the incident light penetrating through the lens module and a peripheral area surrounding the light sensitive area. The cover plate is disposed on the image sensor. The optical pattern is disposed on the cover plate and located above the light sensitive area of the image sensor.

In one or more embodiments, the optical pattern includes microstructure covering PDAF pixels of the image sensor in a light incident direction respectively.

In one or more embodiments, the area of the optical pattern is substantially the same as or larger than the light sensitive area of the image sensor.

In one or more embodiments, the optical pattern substantially covers the light sensitive area of the image sensor in a light incident direction.

In one or more embodiments, the image sensing module further includes at least one first alignment mark on the cover class, and the lens module further includes at least one second alignment mark for aligning with the first alignment mark respectively.

In one or more embodiments, the camera apparatus further includes a substrate for mounting the image sensing device.

In one or more embodiments, the camera apparatus further includes a holder on the image sensing module for accommodating the lens module.

In one or more embodiments, the camera apparatus further includes an infrared (IR) cut-off filter in the holder and between the image sensing module and the lens module.

In one or more embodiments, the substrate is a printed circuit board (PCB).

In one or more embodiments, the substrate is a flexible printed circuit (FPC) board.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 illustrates a schematic cross-sectional diagram of a camera apparatus in accordance with some embodiments of the invention.

FIG. 2 illustrates an arrangement of an optical pattern, a cover plate and an image sensor in accordance with some embodiments of the invention.

FIG. 3 illustrates another arrangement of an optical pattern, a cover plate and an image sensor in accordance with some embodiments of the invention.

FIG. 4 illustrates an alignment mark on a cover plate for alignment with a lens module in accordance with some embodiments of the invention.

FIG. 5 illustrates a method of fabricating an image sensing module in accordance with some embodiments of the invention.

FIG. 6 illustrates another method of fabricating an image sensing module in accordance with some embodiments of the invention.

### DETAILED DESCRIPTION

In the following description, the disclosure will be explained with reference to embodiments thereof. However, these embodiments are not intended to limit the disclosure to any specific environment, applications or particular implementations described in these embodiments. Therefore, the description of these embodiments is only for the purpose of illustration rather than to limit the disclosure. In the following embodiments and attached drawings, elements not directly related to the disclosure are omitted from depiction; and the dimensional relationships among individual elements in the attached drawings are illustrated only for ease of understanding, but not to limit the actual scale.

It will be understood that, although the terms “first” and “second” may be used herein to describe various elements, components, regions, layers and/or sections, these elements, components, regions, layers and/or sections should not be limited by these terms. These terms are only used to distinguish one element, component, region, layer or section from another.

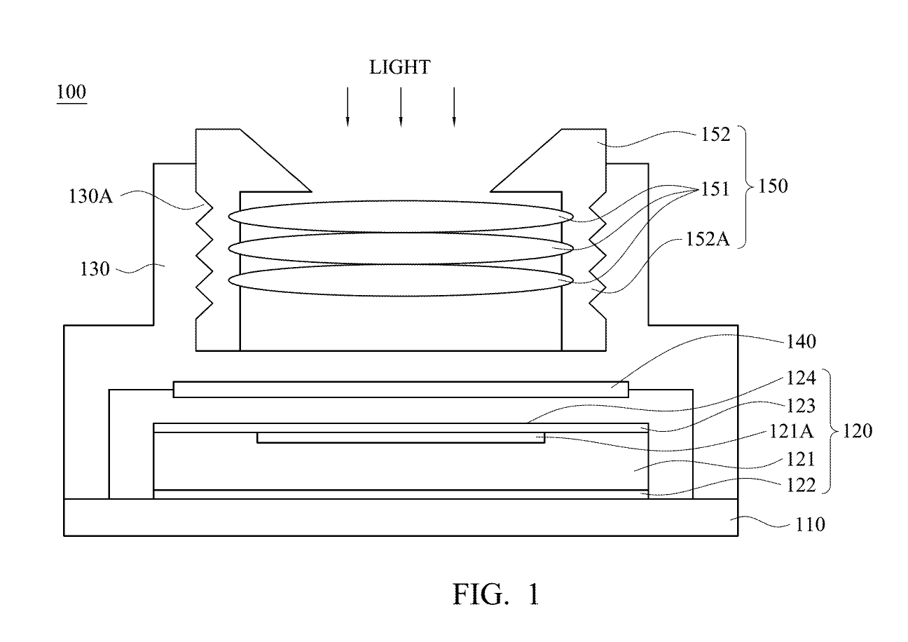

Referring to FIG. 1, FIG. 1 illustrates a camera apparatus 100 in accordance with some embodiments of the invention. In FIG. 1, the camera apparatus 100 includes a substrate 110, an image sensing module 120, a holder 130, an infrared (IR) cut-off filter 140 and a lens module 150. The substrate 110 may be a printed circuit board (PCB), a flexible printed circuit (FPC) board, or the like. In some embodiments, an image processing chip may be disposed on the substrate 110 for receiving and converting the electrical signals into image data.

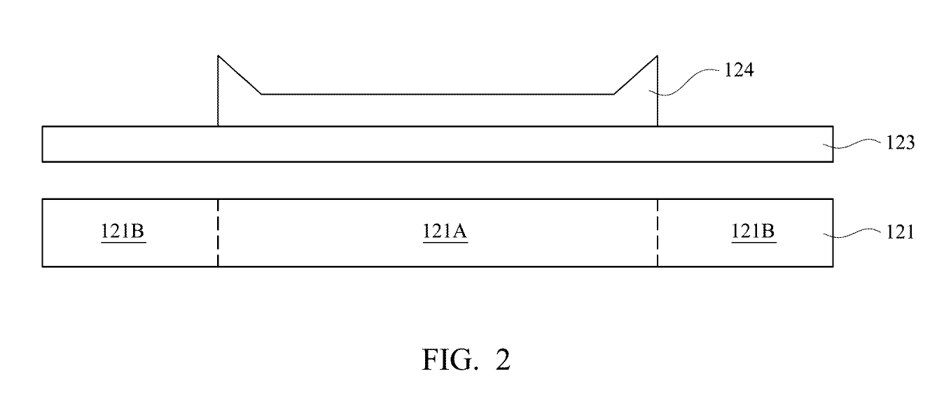

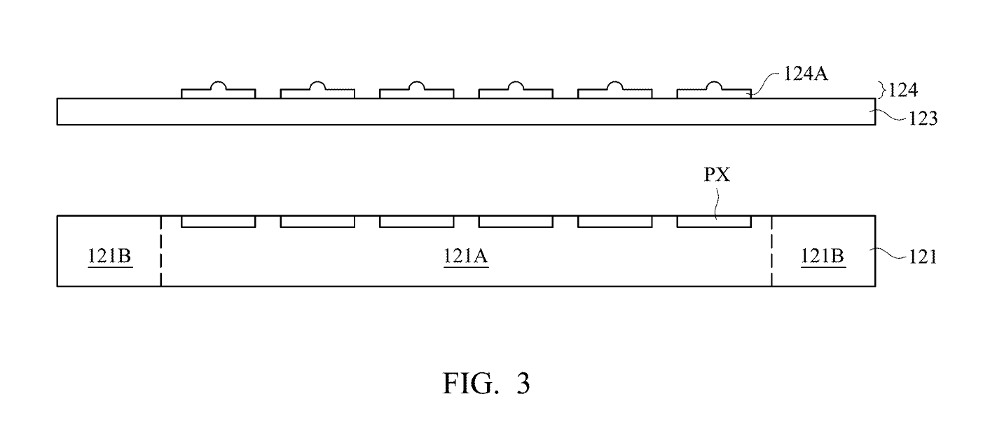

The image sensing module 120 is disposed on the substrate 110. The image sensing module 120 includes an image sensor 121, an adhesive layer 122, a cover plate 123 and an optical pattern 124. The image sensor 121 includes a light sensitive area 121A and a peripheral area 121B (shown in FIGS. 2-3), where the light sensitive area 121A is configured to convert incident light into electrical signals, and the peripheral area 121B includes logic circuits that are configured to process the electrical signals form the light sensitive area 121A. The image sensor 121 may be a complementary metal oxide semiconductor (CMOS) image sensor (CIS) or a charge-coupled device (CCD) image sensor. In addition, the image sensor 121 may be a back-side illuminated (BSI) image sensor or a front-side illuminated (FSI) image sensor.

The image sensing module 120 is mounted on the substrate 110 through the adhesive layer 122. The image sensing module 120 may be mounted on the substrate 110 by a packaging method such as surface mount technology (SMT), chip on board (COB), ceramic leadless chip carrier (CLCC) packaging, chip scale packaging (CSP), through silicon via (TSV), ball grid array (BGA), but is not limited thereto. For example, in the case of COB, the adhesive layer 122 is provided on the image sensor 121, and then metal leading wires are disposed connecting the image sensor 121 and the substrate 110 for providing electrical transmission paths between the image sensor 121 and the substrate 110. The adhesive layer 122 may include a dielectric material such as boron, amorphous silicon, carbon, tantalum nitride, titanium nitride, combinations thereof, or the like. Such exemplary packaging methods are known to those skilled in the art and thus, detailed descriptions thereof are not provided herein.

The cover plate 123 is disposed on the image sensor 121. The cover plate 123 is a transparent structure, which includes a material such as glass, resin, epoxy, or silicone-base polymer, but is not limited thereto. In some embodiments, the cover plate 123 is spaced from the image sensor 121 at a distance of about 10 micrometers.

The optical pattern 124 is disposed on the cover plate 123. The optical pattern 124 is a transparent structure, which includes a material such as glass, resin, epoxy, or silicone-base polymer, but is not limited thereto. The optical pattern 124 may be made by monolithic process technology or wafer-level process technology. In some embodiments, the refractive index of the cover plate 123 is higher than that of the optical pattern 124. In some embodiments, the optical pattern 124 and the cover plate 123 are integrated to form an integrated structure.

The holder 130 is disposed on the substrate 110 and defines a space for accommodating the lens module 150. The IR cut-off filter 140 is disposed in the holder 130 and between the image sensing module 120 and the lens module 150 for preventing IR component of incident light from being incident to the image sensing module 120. The lens module 150 includes optical lenses 151 and a lens barrel 152. The optical lenses 151 are configured to receive and direct incident light toward the image sensing module 120. The lens barrel 152 is configured to accommodate the optical lenses 151. The lens module 150 also includes a control circuit (not shown) for adjusting the positions of the optical lenses 151.

As illustrated in FIG. 1, the inner area of the holder 130 includes a fixing structure 130A. Also, the outer area of the lens barrel 152 includes a fixing structure 152A, such that the lens module 150 can be fixed in the space. In some embodiments, the fixing structures 152A and 130A are screw structures including matching grooves and lands respectively.

Referring to FIG. 2, FIG. 2 illustrates an arrangement of the optical pattern 124, the cover plate 123 and the image sensor 121 in accordance with some embodiments of the invention. In a light incident direction, the peripheral area of the optical pattern 124 substantially covers the light sensitive area 121A of the image sensor 121. As shown in FIG. 2, at the peripheral portion of the optical pattern 124, the thickness of the optical pattern 124 decreases toward the center of the optical pattern 124. As such, light absorption efficiency of the peripheral portion of the image sensitive area 121A can be enhanced and, therefore, the chief ray angle (CRA) of the lens module 150 can be enlarged, and correction of image distortion preformed by an image signal processor can be optimized.

Referring to FIG. 3, FIG. 3 illustrates another arrangement of the optical pattern 124, the cover plate 123 and the image sensor 121 in accordance with some embodiments of the invention. The image sensor 121 includes phase detection auto focus (PDAF) pixels 121A used for focal length calculation. The use of PDAF pixels 121A is well known to those skilled in the art and, therefore, not described herein. The optical pattern 124 includes microstructures 124A each mapping to one of the PDAF pixels 121A. The microstructure 124A respectively covers the PDAF pixels 121A in a light incident direction. Thus, incident light absorption of the PDAF pixels 121A is enhanced, so as to improve focal length calculation efficiency and accuracy.

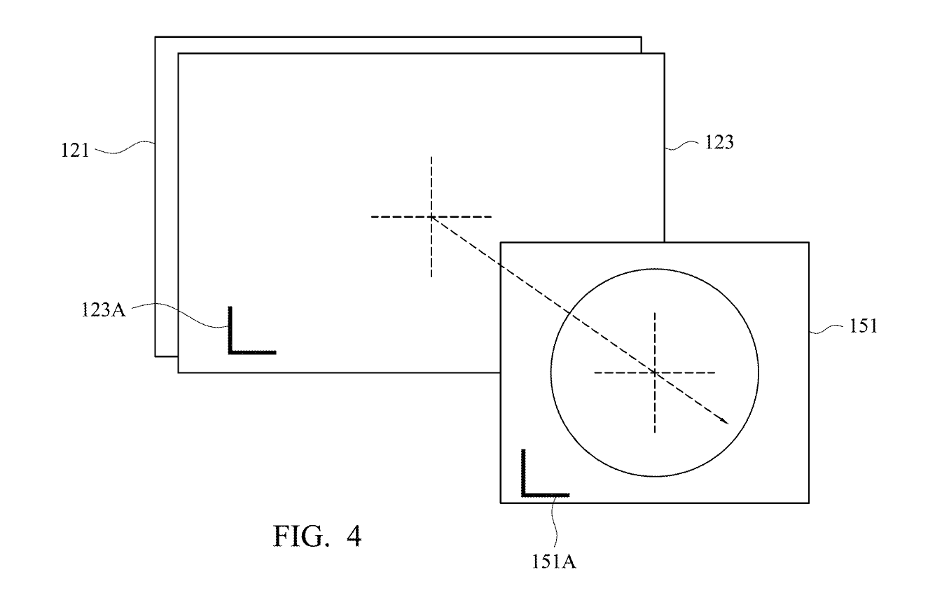

Referring to FIG. 4, FIG. 4 illustrates an alignment mark 123A on a cover plate 123 for alignment with a lens module 150 in accordance with some embodiments of the invention. The alignment mark 123A is located above the peripheral area of the image sensor 121 to avoid affecting incident light reception of the image sensor 121. The alignment mark 123A may be printed, stuck or pasted on the cover plate 123. Alternatively, the alignment mark 123A may be formed on the cover plate 123 along with the formation of the optical pattern 124. One corner of the optical lenses 151 also includes an alignment mark 151A. The alignment marks 151A and 123A may help precisely tuning relative positions between the lens module 150 and the image sensing module 120. In some embodiments, the lenses 151 and the cover plate 123 may include more than one alignment mark 151A and one alignment mark 123A respectively.

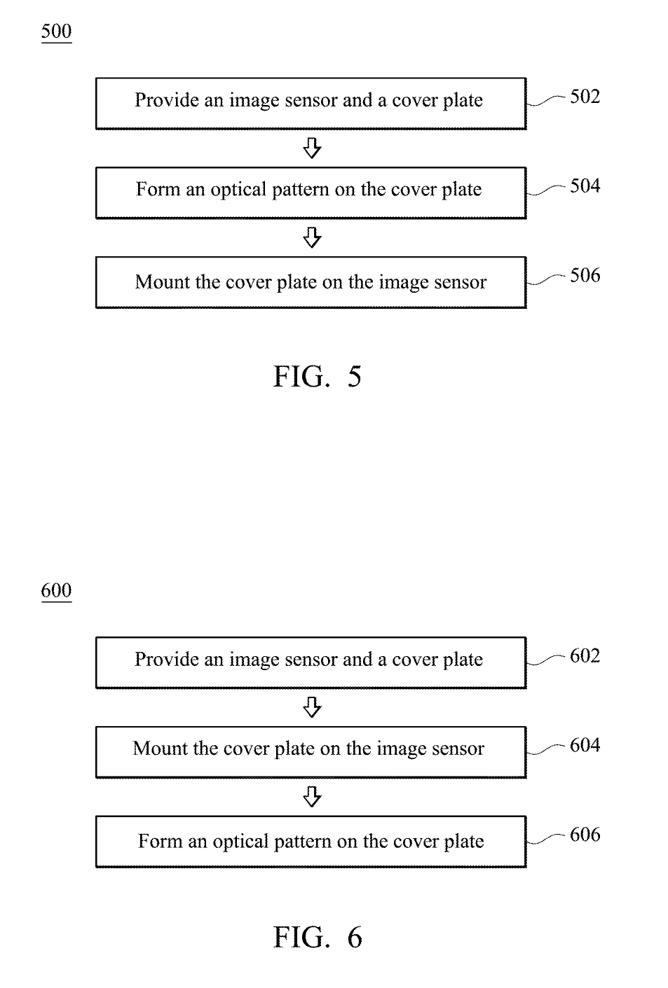

Referring to FIG. 5, FIG. 5 illustrates a method 500 of fabricating an image sensing module in accordance with some embodiments of the invention. The method 500 begins at step 502, in which an image sensor and a cover plate are provided. The image sensor includes a light sensitive area and a peripheral area, where the light sensitive area is configured to convert incident light into electrical signals, and the peripheral area includes logic circuits that are configured to process the electrical signals form the light sensitive area. The cover plate may be provided including a material such as glass, resin, epoxy, or silicone-base polymer, but is not limited thereto.

At step 504, an optical pattern is formed on the cover plate. The optical pattern may include a material such as resin, glass, resin, epoxy, or silicone-base polymer, but is not limited thereto. In some embodiments, the material of the optical pattern is the same as that of the cover plate. The optical pattern may be formed by performing a lithography process and an etching process. The lithography process may be performed by using a process such as spin-on coating, CVD, PECVD, HDPCVD, PVD, ALD, combinations thereof, or the like. The etching process may be performed by using an etching technique such as dry etching, a wet etching, chemical etching, or other suitable etching technique. Alternatively, in some embodiments, the optical pattern may be formed by performing a laser removing technique.

At step 506, the cover plate is mounted on the image sensor. The cover plate may be mounted on the image sensor by a wafer mount process or an IC module process. In some embodiments, the cover plate is mounted spacing from the image sensor at a distance of about 10 micrometers.

Alternatively, the cover plate may be mounted on the image sensor before forming the optical pattern thereon. Referring to FIG. 6, FIG. 6 illustrates a method 600 of fabricating an image sensing module in accordance with some embodiments of the invention. The method 600 begins at step 602, in which an image sensor and a cover plate are provided. The image sensor includes a light sensitive area and a peripheral area, where the light sensitive area is configured to convert incident light into electrical signals, and the peripheral area includes logic circuits that are configured to process the electrical signals form the light sensitive area. The cover plate may be provided including a material such as glass, resin, epoxy, or silicone-base polymer, but is not limited thereto.

At step 604, the cover plate is mounted on the image sensor. The cover plate may be mounted on the image sensor by a wafer mount process or an IC module process. In some embodiments, the cover plate is mounted spacing from the image sensor at a distance of about 10 micrometers.

At step 606, an optical pattern is formed on the cover plate. The optical pattern may include a material such as resin, glass, resin, epoxy, or silicone-base polymer, but is not limited thereto. In some embodiments, the material of the optical pattern is the same as that of the cover plate. The optical pattern is formed by performing a lithography process and an etching process. The lithography process may performed by using a process such as spin-on coating, CVD, PECVD, HDPCVD, PVD, ALD, combinations thereof, or the like. The etching process may be performed by using an etching technique such as dry etching, a wet etching, chemical etching, or other suitable etching technique. Alternatively, in some embodiments, the optical pattern may be formed by performing a laser removing technique.

Summing the above, the image sensing module of the invention includes a cover plate with an optical pattern disposed thereon, and such optical pattern helps improve image sensing quality and color shift of the image sensing module. A camera apparatus with the image sensing module can correct image date distortion and improve CRA performance and focal length calculation accuracy.

Although the disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the disclosure without departing from the scope or spirit of the disclosure. In view of the foregoing, it is intended that the disclosure cover modifications and variations of this disclosure provided they fall within the scope of the following claims.

What is claimed is:

1. An image sensing module, comprising:
an image sensor having a light sensitive area for receiving incident light and a peripheral area surrounding the light sensitive area;
a cover plate on the image sensor; and
an optical pattern on the cover plate, the optical pattern located above the light sensitive area of the image sensor.

2. The image sensing module of claim 1, wherein the optical pattern comprises a plurality of microstructures, the microstructures substantially covering a plurality of phase detection auto focus (PDAF) pixels of the image sensor in a light incident direction respectively.

3. The image sensing module of claim 1, wherein the area of the optical pattern is substantially the same as or larger than the light sensitive area of the image sensor.

4. The image sensing module of claim 1, wherein the optical pattern substantially covers the light sensitive area of the image sensor in a light incident direction.

5. The image sensing module of claim 1, further comprising at least one alignment mark on the cover class for a lens module to be aligned with the image sensing module, the at least one alignment mark located above the peripheral area of the image sensor.

6. A method of fabricating an image sensing module, comprising:
providing an image sensor having an light sensitive area for receiving incident light and a peripheral area surrounding the light sensitive area;
mounting a cover plate on the image sensor, the cover plate having an optical pattern formed thereon, and the optical pattern located above the light sensitive area of the image sensor.

7. The method of claim 6, wherein the optical pattern is formed to comprise a plurality of microstructures, the microstructures substantially covering a plurality of phase detection auto focus (PDAF) pixels of the image sensor in a light incident direction respectively.

8. The method of claim 6, wherein the area of the optical pattern is substantially the same as or larger than the light sensitive area of the image sensor.

9. The method of claim 6, wherein the optical pattern is formed to substantially cover the light sensitive area of the image sensor in a light incident direction.

10. The method of claim 6, further comprising:
forming at least one alignment mark on the cover class for a lens module to be aligned with the image sensing module, the at least one alignment mark located above the peripheral area of the image sensor.

11. A camera apparatus, comprising:
a lens module for directing incident light; and
an image sensing module comprising:
an image sensor having a light sensitive area for receiving the incident light penetrating through the lens module and a peripheral area surrounding the light sensitive area;
a cover plate on the image sensor; and
an optical pattern on the cover plate, the optical pattern located above the light sensitive area of the image sensor.

12. The camera apparatus of claim 11, wherein the optical pattern comprises a plurality of microstructures, the microstructures substantially covering a plurality of phase detection auto focus (PDAF) pixels of the image sensor in a light incident direction respectively.

13. The camera apparatus of claim 11, wherein the area of the optical pattern is substantially the same as or larger than the light sensitive area of the image sensor.

14. The camera apparatus of claim 11, wherein the optical pattern substantially covers the light sensitive area of the image sensor in a light incident direction.

15. The camera apparatus of claim 11, wherein the image sensing module further comprises at least one first alignment mark on the cover class, and the lens module further comprises at least one second alignment mark for aligning with the at least one first alignment mark respectively.

16. The camera apparatus of claim 11, further comprising a substrate for mounting the image sensing device.

17. The camera apparatus of claim 16, further comprising a holder on the substrate for accommodating the lens module.

18. The camera apparatus of claim 17, further comprising an infrared (IR) cut-off filter in the holder and between the image sensing module and the lens module.

19. The camera apparatus of claim 16, wherein the substrate is a printed circuit board (PCB).

20. The camera apparatus of claim 16, wherein the substrate is a flexible printed circuit (FPC) board.
